(19) United States
(12) Patent Application Publication
(10) Pub. No.: US 2024/0177202 A1
(43) Pub. Date: May 30, 2024

(54) SYSTEM AND METHOD FOR COMPETITIVE PRODUCT ANALYSIS

(71) Applicant: Dell Products L.P., Round Rock, TX (US)

(72) Inventors: Ruwan Asanka WASALA, Limerick (IE); Shuvaday CHATTERJEE, Bangalore (IN)

(73) Assignee: Dell Products L.P., Round Rock, TX (US)

(21) Appl. No.: 18/059,066

(22) Filed: Nov. 28, 2022

(51) Int. Cl. G06Q 30/0282

(52) U.S. Cl. CPC G06Q 30/0282

(57) ABSTRACT

In one aspect, an example methodology implementing the disclosed techniques includes, by a computing device, retrieving a plurality of posts collected from one or more online forums, social media platforms, or other websites and filtering the plurality of posts, wherein the filtering identifies one or more posts which discuss products which are of interest for a product analysis. The method also includes, by the computing device, classifying, using a machine learning (ML) model, individual posts of the filtered posts as a comparative post or a noncomparative post, wherein the posts classified as comparative posts are used for the product analysis, and extracting information from the comparative posts, wherein the information is to be used for the product analysis. The method further includes storing the extracted information within a data repository.

### BACKGROUND

User generated content (UGC) is any form of content that is posted by users on online platforms, such as social media and discussion forums. Such content, including customer reviews of products, continues to grow. A customer review typically reflects a customer's experience with a product. For example, a customer can post a review describing their evaluation of a product on a social media platform. These reviews can allow current, or potential users of a product to benefit from feedback provided by prior users who have experience with the product. For example, potential customers often consult reviews and testimonials during their product purchase journey to compare the pros and cons among the competing products and make their purchasing decision based on their requirements.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, retrieving a plurality of posts collected from one or more online forums, social media platforms, or other websites and filtering the plurality of posts, wherein the filtering identifies one or more posts which discuss products which are of interest for a product analysis. The method also includes, by the computing device, classifying, using a machine learning (ML) model, individual posts of the filtered posts as a comparative post or a noncomparative post, wherein the posts classified as comparative posts are used for the product analysis, and extracting information from the comparative posts, wherein the information is to be used for the product analysis. The method further includes, by the computing device, storing the extracted information within a data repository.

In some embodiments, the filtering includes filtering content of the plurality of posts using keywords indicative of comparison and names of products which are of interest for the product analysis. In one aspect, at least one keyword of the keywords is derived from historical posts. In one aspect, the one or more posts which discuss products which are of interest for a product analysis are identified based on a threshold match percentage of the keywords indicative of comparison and the names of products which are of interest for the product analysis.

In some embodiments, the filtering includes filtering content of the plurality of posts using lexico-syntactic pattern matching. In one aspect, the lexico-syntactic pattern matching is of titles of the plurality of posts. In one aspect, the lexico-syntactic pattern matching includes applying one or more syntactic rules to titles of the plurality of posts. In one aspect, at least one of the one or more syntactic rules is derived from historical comparative posts.

In some embodiments, the filtering includes filtering content of the plurality of posts using keywords indicative of comparison and names of products which are of interest for the product analysis and lexico-syntactic pattern matching.

In some embodiments, the ML model is trained using instances of historical posts labeled as either comparative or noncomparative.

In some embodiments, the method also includes, by the computing device, retrieving, from the data repository, the information extracted from the comparative posts, and generating a product analysis report using the information retrieved from the data repository.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a block diagram of an illustrative system for competitive product analysis, in accordance with an embodiment of the present disclosure.

FIG. 5 is a flow diagram of an example process for analysis of competitive products, in accordance with an embodiment of the present disclosure.

### DETAILED DESCRIPTION

In the following description, certain embodiments and/or examples of the concepts, techniques, and structures are described in the context of electronic devices to facilitate understanding. It will be appreciated in light of this disclosure that such embodiments and/or examples are not restricted as such but can be applicable to other types of products that are manufactured and/or sold, such as, for example, automobiles and appliances, among others.

Product reviews can be very helpful to users in making the decision to purchase a specific product. Product reviews can also bring new opportunities for product feature and configuration analysis to organizations, such as companies that manufacture products. For example, customer product reviews posted on social media platforms are a potentially valuable information that can be used for understanding the strengths and weaknesses of an organization's product and competing products as well as the product features that are important to users in making a purchase decision. Unfortunately, product reviews, and user generated content (UGC) in general, typically include extremely broad and freeform textual content. Accordingly, UGC is traditionally difficult to search to discover posts which compare a product which is of interest (or “focal product”) and competing products, and to extract information from such posts.

Certain embodiments of the concepts, techniques, and structures disclosed herein are directed to an artificial intelligence (AI)/machine learning (ML)-powered framework for competitive product analysis. The AI/ML-powered framework provides periodic scraping and analysis of product reviews (e.g., reviews about a particular product or product category) from various online forums including social media platforms, such as FACEBOOK, TWITTER, REDDIT, and other websites. In some such embodiments, the web content (or “online content”) can be scraped for posts that compare two or more products belonging to a same category of products by at least two vendors. For a given such post, information (e.g., comments and contents) indicative of the individual products discussed, including important product features of the compared products, pros and cons of the product features, and sentiment, can be extracted from the post. The extracted information can be stored in a data repository and used for deriving insights about individual products as perceived by customers.

In some embodiments, the AI/ML-powered framework includes a preprocessing phase, a keyword filtering phase, a lexico-syntactic pattern-based filtering phase, a post classification phase, and an information extraction phase. As will be appreciated, these phases are used for purposes of facilitating discussion and should not be construed as structural or otherwise rigid limitations. For instance, the keyword filtering phase and the lexico-syntactic pattern-based filtering phase may be combined into a single phase between the preprocessing phase and the post classification phase, wherein that single phase receives the output of the preprocessing phase as input and outputs posts that compare products that are of interest for the product analysis. In short, any number of phases can be used to provide the various functionality provided herein.

In the preprocessing phase, various preprocessing operations can be performed to normalize and clean the contents of the individual posts to facilitate subsequent text filtering processing of the posts. In some embodiments, natural language processing (NLP) techniques may be utilized to preprocess the text of the individual posts. For example, the preprocessing of the text may include operations such as punctuation removal, noise removal, lower casing of the words, spelling and grammar correction, acronym/abbreviation resolution, and lemmatization.

In the keyword filtering phase, the preprocessed posts resulting from the preprocessing phase can be filtered to remove (i.e., eliminate) posts which do not involve any product comparisons. Such posts are sometimes referred to herein as “noncomparative posts” as opposed to the “comparative posts” which involve (or “discuss”) product comparisons. In some embodiments, the title and contents of the individual preprocessed posts may be checked for predetermined keywords (e.g., a predetermined set of keywords) indicative of comparison as well as product model names and brands that are of interest for the product analysis. As a result, the posts which involve comparisons of products that are of interest to the organization (e.g., the comparative posts which discuss products that are of interest) can be identified and the other posts (e.g., the posts which do not discuss products which are of interest for the product analysis) can be eliminated from further processing.

In the lexico-syntactic pattern-based filtering phase, the filtered posts resulting from the keyword filtering phase can be filtered to further eliminate the posts which do not discuss products. It is appreciated that the posts resulting from the keyword filtering phase may include noncomparative posts (e.g., the keyword filtering may not eliminate all the posts which do not discuss products). In some embodiments, the titles of the individual posts may be analyzed utilizing lexico-syntactic pattern matching (e.g., grammar-based pattern matching) techniques to identify the posts which involve comparisons of products that are of interest for the product analysis and further eliminate the noncomparative posts. In some such embodiments, the titles may be analyzed utilizing syntactic tags and patterns, such as, for example, part-of-speech (POS) tags and grammar patterns, to identify posts which involve comparisons of products. The tags and patterns used to check or otherwise process the titles can be derived from historical data (e.g., derived from analyzing historical data).

In the post classification phase, the filtered posts resulting from the lexico-syntactic pattern-based filtering phase can be classified to further eliminate noncomparative posts. It is appreciated that the posts resulting from the lexico-syntactic pattern-based filtering phase may still include noncomparative posts (e.g., the lexico-syntactic pattern-based filtering may not eliminate all the noncomparative posts). In some embodiments, a trained machine learning (ML) model may be used to classify a post as either a comparative post or a noncomparative post. For example, the training dataset can include a corpus of historical posts collected from various sources labeled as either comparative or noncomparative. The training dataset can be used to train the ML model, where the training can configure the model to learn from the training dataset to classify a post (e.g., a new post) as either a comparative post or a noncomparative post. In some such embodiments, the ML model may be trained to classify a post based on the title of the post. As a result, the posts which do not focus on product comparisons can be filtered and eliminated. The posts classified as comparative posts can then be used for the product analysis and insight generation.

In the information extraction phase, information can be extracted from the posts resulting from the post classification phase. The information extracted from the posts can include comments and other content about the individual products discussed in the posts, such as, for example, product identifiers (IDs) and/or names, attributes and features of the compared products, pros and cons of the compared products, sentiment of the comments, recommendation, and/or reason for the recommendation, to provide some examples. In some embodiments, NLP techniques may be utilized to extract the information which is of interest from the individual posts. The information extracted from the posts can be stored within a data repository and used, for example, to derive insights about the individual products.

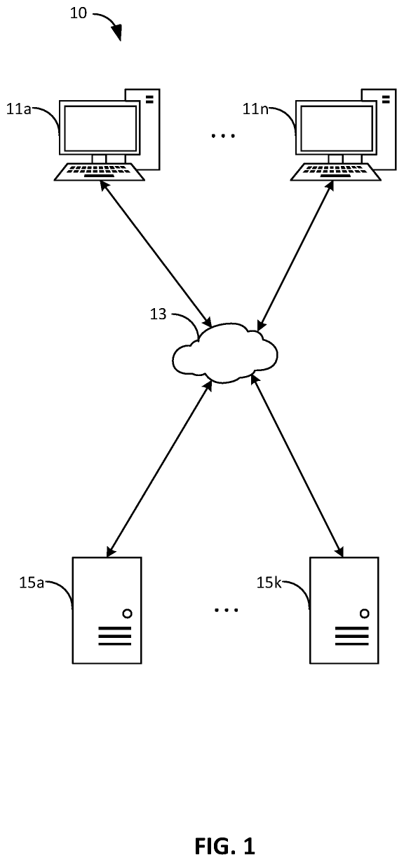

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

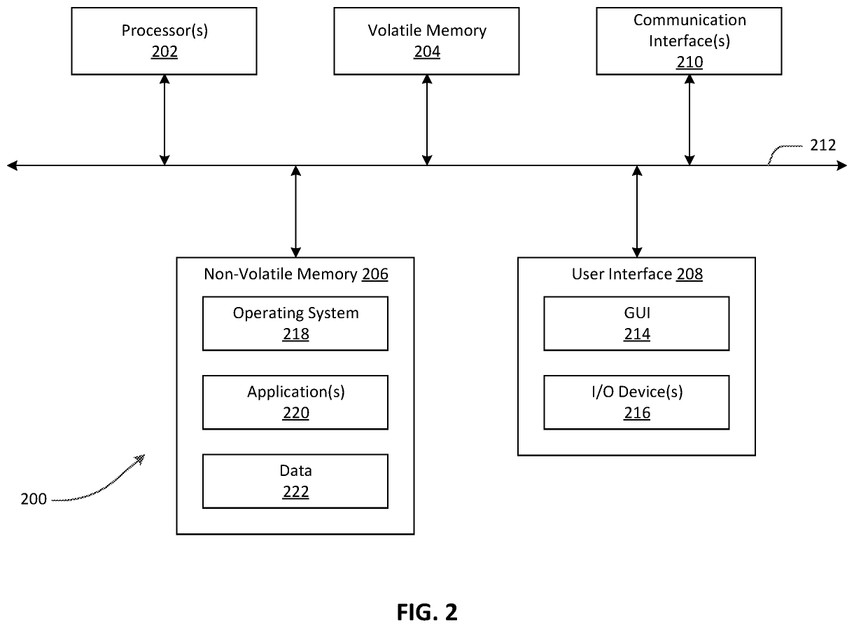

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

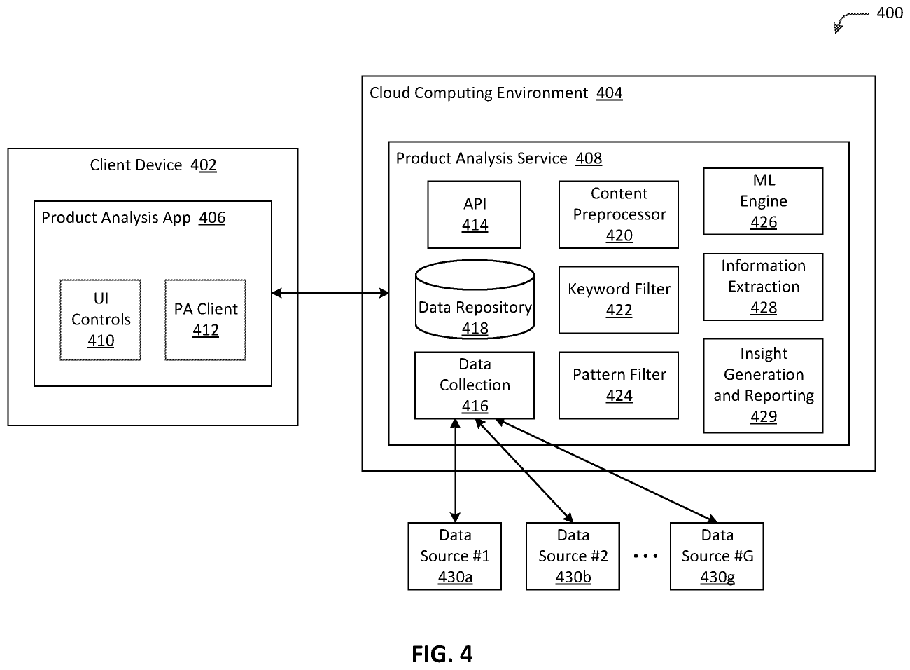

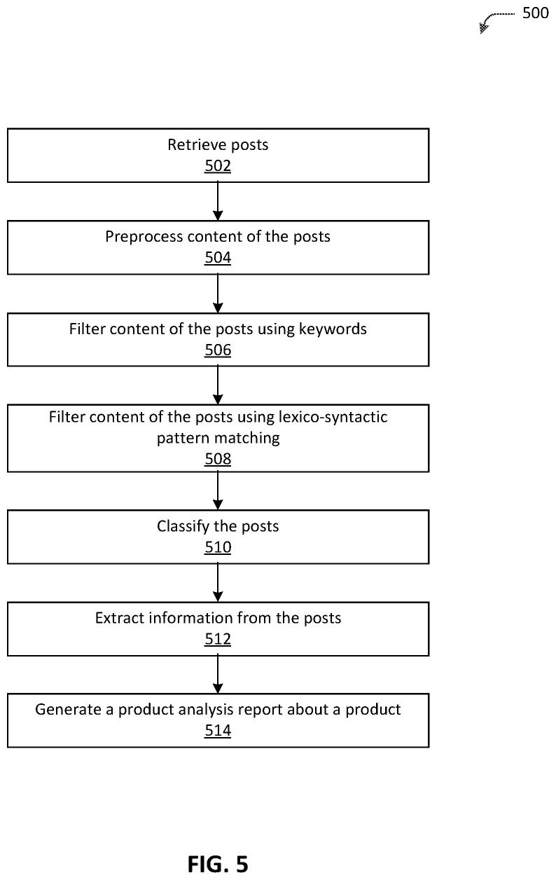

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 and 5). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

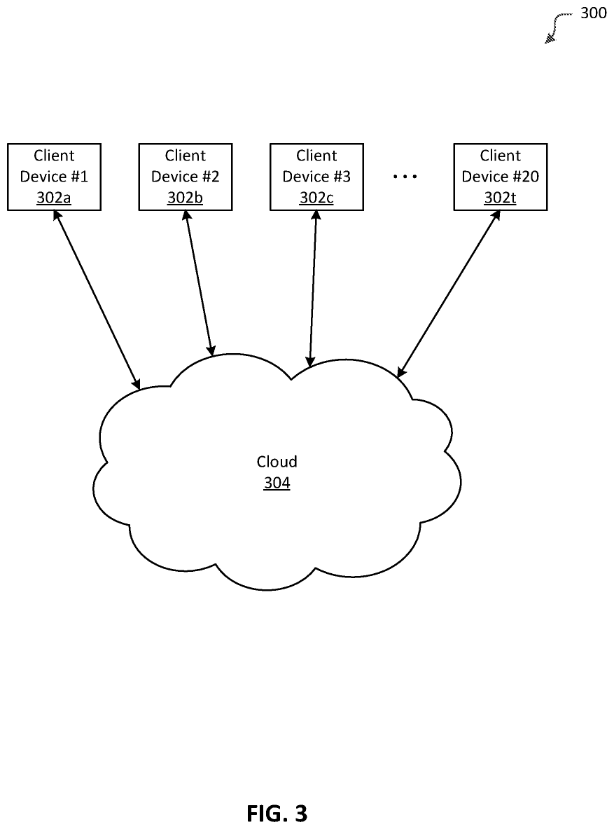

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified time period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a block diagram of an illustrative system 400 for competitive product analysis, in accordance with an embodiment of the present disclosure. Illustrative system 400 includes a product analysis application 406 running on a client device 402 and configured to communicate with a cloud computing environment 404 via one or more computer networks. Client device 402 and cloud computing environment 404 of FIG. 4 can be the same as or similar to client 11 of FIG. 1 and cloud computing environment 300 of FIG. 3, respectively.

As shown in FIG. 4, a product analysis service 408 can be provided as a service (e.g., a microservice) within cloud computing environment 404. Product analysis application 406 and product analysis service 408 can interoperate to provide competitive product analysis and extraction of important product features, as variously disclosed herein. To promote clarity in the drawings, FIG. 4 shows a single product analysis application 406 communicably coupled to product analysis service 408. However, embodiments of product analysis service 408 can be used to service many client applications (e.g., product analysis applications 406) running on clients (e.g., client devices 402) associated with one or more organizations and/or users. Product analysis application 406 and/or product analysis service 408 may be implemented as computer instructions executable to perform the corresponding functions disclosed herein. Product analysis application 406 and product analysis service 408 can be logically and/or physically organized into one or more components. In the example of FIG. 4, product analysis application 406 includes UI controls 410 and a product analysis (PA) client 412. Also, in this example, product analysis service 408 includes an application programming interface (API) module 414, a data collection module 416, a data repository 418, a content preprocessor module 420, a keyword filter module 422, a pattern filter module 424, an ML engine 426, an information extraction module 428, and an insight generation and reporting module 429.

The client-side product analysis application 406 can communicate with the cloud-side product analysis service 408 using an API. For example, product analysis application 406 can utilize PA client 412 to send requests (or “messages”) to product analysis service 408 wherein the requests are received and processed by API module 414 or one or more other components of product analysis service 408. Likewise, product analysis service 408 can utilize API module 414 to send responses/messages to product analysis application 406 wherein the responses/messages are received and processed by PA client 412 or one or more other components of product analysis application 406.

Product analysis application 406 can include various UI controls 410 that enable a user, such as a product designer or other associate within or associated with an organization, to access and interact with product analysis service 408. For example, UI controls 410 can include UI elements/controls, such as input fields and text fields, that a user can use to enter (e.g., specify) a name of a product (e.g., a product model) that is to be analyzed. UI controls 410 can also include input fields or text fields that the user can use to enter names of one or more other brands that are to be considered for the product analysis (e.g., names of other brands whose corresponding products are of interest for the product analysis). For example, suppose the user is interested in an analysis of the DELL XPS 7390 laptop and the corresponding products offered by LENOVO and HP. In this example, the user can use UI controls 410 to enter “DELL XPS 7390 laptop” as the name of the product which is to be analyzed, and “Lenovo” and “HP” as the names of the other brands to be considered for the product analysis. Generally, UI controls 410 can include controls/elements that a user can use to input information about a product (e.g., the organization's product) that is to be analyzed and one or more other brands that are to be considered in the product analysis. UI controls 410 can include UI elements/controls that a user can click/tap to request analysis of the specified product and the specified other brands that are to be considered. In response to the user's input, product analysis application 406 can send a message to product analysis service 408 requesting an analysis of the specified product and corresponding products offered by the specified one or more other brands to be considered for the product analysis.

Product analysis application 406 can also include various UI controls 410 that enable a user to view a product analysis report. For example, in some embodiments, responsive to sending a request (e.g., a product analysis request) for an analysis of a product and one or more other brands, product analysis application 406 may receive a response from product analysis service 408 which includes a product analysis report detailing the results of the analysis of the product and the other brands. For example, a product analysis report about a product can include information extracted from posts which discuss the product and/or comparisons of the product, such as attributes and features of the product and any compared products, pros and cons of the compared products, sentiment of the comments, recommendation, and reason for the recommendation. UI controls 410 can include a button or other type of control/element for displaying a product analysis report, for example, on a display connected to or otherwise associated with client device 402.

In the embodiment of FIG. 4, product analysis application 406 is shown as a stand-alone client application. In other embodiments, product analysis application 406 may be implemented as a plug-in or extension to another application (e.g., a web browser) on client device 402, such as, for example, an enterprise client application. In such embodiments, UI controls 410 may be accessed within the other application in which product analysis application 406 is implemented (e.g., accessed within the enterprise client application).

Referring to the cloud-side product analysis service 408, data collection module 416 is operable to collect (or “scrape”) posts and other content shared by users (e.g., UGC) (collectively referred to herein more simply as “posts”) from one or more data sources 430a-430g (individually referred to herein as data source 430 or collectively referred to herein as data sources 430). In some embodiments, data sources 430 can include various online forums including social media platforms (e.g., social media sites), such as FACEBOOK, TWITTER, REDDIT, and other websites. Data sources 430 can also include product review sites including product manufacturer websites where comments/reports/discussions about a manufacturer's products can be found. For example, data collection module 416 may scrape text posts from FACEBOOK. As another example, data collection module 416 may scrape tweets from TWITTER. In some embodiments, data collection module 416 can collect the posts which are published (e.g., posted) within the past N months (e.g., N=24) from the one or more data sources 430. The value of N may be configurable by the organization.

In some embodiments, data collection module 416 can scan, parse, or otherwise analyze the collected posts to identify and record information therefrom. For example, for a particular post, data collection module 416 can extract and record the identifier, the author, the title, and the contents from the post. In some embodiments, data collection module 416 can store (e.g., record) the information extracted from the posts (e.g., identifier, author, title, and contents) within data repository 418, where it can subsequently be retrieved and used. For example, the recorded information extracted from the posts can be retrieved from data repository 418 and used to filter the posts to identify comparative posts which discuss products that are of interest for the product analysis. In some embodiments, data repository 418 may correspond to a storage service within the computing environment of product analysis service 408.

Data collection module 416 can utilize application programming interfaces (APIs) provided by the various data sources to collect posts therefrom. For example, data collection module 416 can use a Hypertext Transfer Protocol (HTTP)-based API (e.g., the FACEBOOK graph API) provided by FACEBOOK to collect the text posts therefrom. As another example, data collection module 416 can use the TWITTER API provided by TWITTER to collect the tweets therefrom. As another example, data collection module 416 can use the REDDIT API provided by REDDIT to collect the posts therefrom. In cases where a data source does not provide an interface or API, other means, such as programmatic web scraping methodologies, may be adopted to collect posts therefrom. Additionally, optical character recognition (OCR) technologies may be used for obtaining information from printed materials (e.g., books, newspapers, articles, etc.) and PDF documents.

In some embodiments, data collection module 416 can collect the posts from one or more of the various data sources on a continuous or periodic basis (e.g., according to a predetermined schedule specified by the organization). In some embodiments, data collection module 416 can store the posts collected from the various data sources within data repository 418, where it can subsequently be retrieved and used.

The particular data sources 430a-430g used by data collection module 416 can vary between different organizations and/or between different users of the same organization. In some embodiments, the data sources from which to collect the posts can be configured as part of an organizational policy or a user preference. For example, the organization can define a product analysis policy which specifies the data sources from which data collection module 416 is to collect the posts. Data collection module 416 can then collect the posts from the data sources specified in the product analysis policy.

Content preprocessor module 420 is operable to preprocess the content of the posts to normalize and clean the text to facilitate subsequent processing of the posts. In one example implementation, content preprocessor module 420 can retrieve the information recorded for the posts (e.g., the identifier, the author, the title, and the contents recorded for the individual post) from data repository 418. In other implementation, content preprocessor module 420 can retrieve the actual posts from data repository 418. In any case, content preprocessor module 420 can preprocess the text of the individual posts to be in a form that is suitable for subsequent processing to identify the comparative posts which discuss products that are of interest for the product analysis. For example, in one embodiment, NLP techniques may be utilized to preprocess the text of the posts (e.g., preprocess the title and contents of the individual posts). For example, the text preprocessing may include operations such as punctuation removal (e.g., removing punctuation from the text data), noise removal (e.g., removing whitespaces, characters, digits, and items of text which can interfere with the filtering of the text), lower casing of the words, spelling and grammar correction, acronym/abbreviation resolution, and lemmatization (e.g., grouping different inflected forms of words into the root form), among other text preprocessing operations.

Keyword filter module 422 is operable to process the content of the posts to identify the posts which discuss products that are of interest for the product analysis. In some embodiments, keyword filter module 422 can filter the preprocessed title and contents of the posts resulting from content preprocessor module 420 for keywords or combination of keywords to identify the posts which discuss products that are of interest for the product analysis. For example, for a particular post, keyword filter module 422 can check the title and contents for predetermined keywords indicative of comparison, such as, for example, “vs,” “versus,” “v,” “between,” “or,” “and,” “good,” “best,” “decide,” “new,” “choice,” “worse,” and “performance,” among others. Keyword filter module 422 can also check the title and contents for a name of a product (e.g., DELL OptiPlex 7000) and names of one or more other brands (e.g., LENOVO and ASUS) that are to be considered for the product analysis (e.g., names of other brands that are to be used for the keyword filtering). Keyword filter module 422 can then determine whether a post is a post which discusses products that are of interest for the product analysis based on the check of the title and contents of the post for the predetermined keywords and the name of the product and the names of the brands that are to be considered for the product analysis.

In some embodiments, keyword filter module 422 can determine whether a post is a post which discusses products that are of interest based on a threshold match percentage, such as, for example, 50%, 60%, 70%, 80%, or another suitable value. For example, a post can be determined to be a post which discusses products that are of interest if the predetermined keywords and the names of the product and the brands found in the title and contents of the post satisfy or exceed the threshold match percentage. Otherwise, if the predetermined keywords and the names of the product and the brands found in the title and contents of a post does not satisfy the threshold match percentage, the post can be determined to be a post which does not discuss products that are of interest. The threshold match percentage can be set by the organization as part of a product analysis policy.

In some embodiments, keyword filter module 422 can eliminate the posts which do not discuss products that are of interest for the product analysis from further processing. As a result, the posts which do not discuss products that are of interest can be excluded from the product analysis.

In some embodiments, the keywords used to filter the posts may be derived systematically leveraging NLP techniques tuned on historical data. For instance, keyword filter module 422 can utilize NLP techniques to continually analyze the historical posts collected from the data sources to understand words and patterns of words which indicate comparison. Keyword filter module 422 can identify or otherwise designate such words and patterns of words as keywords indicative of comparison. As a result, the predetermined keywords indicative of comparison can be updated to include new words and patterns of words which indicate comparison.

Still referring to product analysis service 408, pattern filter module 424 is operable to process the content of posts to identify the posts which discuss products that are of interest for the product analysis. In some embodiments, pattern filter module 424 can filter the title of the posts resulting from keyword filter module 422 using lexico-syntactic pattern matching techniques, such as the rule-matching engine provided by spacCy or another open-source project, to identify the posts which discuss products that are of interest for the product analysis. In this way, pattern filter module 424 can further filter the posts resulting from keyword filter module 422 for posts which do not discuss products. For example, in one embodiment, pattern filter module 424 can apply one or more predetermined syntactic rules, such as, for example, predetermined POS patterns/rules, to the titles of the posts (i.e., the posts resulting from keyword filter module 422) to identify the posts which discuss products. The predetermined syntactic grammar patterns and tags can be derived by analyzing the titles of historical comparative posts.

For example, in one implementation, for a given historical comparative post, POS tagging can be performed on the title (e.g., “Dell XPS/Latitude vs Lenovo ThinkPad?”) to determine the POS tags (e.g., “PROPN PROPN SYM PROPN NOUN SPACE PROPN SPACE PROPN PUNCT”) corresponding to the title. In the POS tags, “PROPN” represents a proper noun. “SYM” represents a symbol, “NOUN” represents a noun, “SPACE” represents a space, and “PUNCT” represents a punctuation. The POS tags corresponding to the title of the historical comparative post can then be analyzed to derive one or more POS rules/patterns which can be used to identify comparative posts. For example, POS patterns “[{‘POS’: ‘PROPN’}, {‘LIKE_NUM’: True}],” “[{‘POS’: ‘PROPN’}, {‘POS’: ‘PROPN’}],” and “[{‘POS’: ‘PROPN’}, {‘POS’: ‘PROPN’}, {“POS”: {“IN”:[“ADP”, “CCONJ”]} }, {‘POS’: ‘PROPN’}, {‘POS’: ‘PROPN’}]” may be derived from an analysis of the POS tags (e.g., “PROPN PROPN SYM PROPN NOUN SPACE PROPN SPACE PROPN PUNCT”) corresponding to the title of the historical comparative post. In the POS rules, the tag “ADP” represents an adposition, the tag “CCONJ” represents a coordinating conjunction, the attribute “POS” means the token's part-of-speech tag, the attribute “LIKE_NUM” means the token is punctuation, and the attribute “IN” means belongs to either of (e.g., whether the POS of the word being analyzed is either ADP or CCONJ). Continuing the above example, given post having a title “Lenovo Yoga Slim vs Lenovo Yoga”, pattern filter module 424 can apply the three POS patterns to the title “Lenovo Yoga Slim vs Lenovo Yoga” and determine that the post is a comparative post. Conversely, given post having a title “Is this any good? Complete noob to this”, pattern filter module 424 can apply the POS patterns to the title “Is this any good? Complete noob to this” and determine that the post is not a comparative post (e.g., determine that the post is a noncomparative post).

In general, the POS patterns/rules derived from the analysis of the POS tags corresponding to titles of historical comparative posts represent sequences of tokens (e.g., grammatical structure) which may be found in titles of posts which discuss products. The derived POS patterns/rules (i.e., the predetermined POS patterns/rules) can then be used to identify posts that are posts which discuss products. For example, the predetermined POS patterns/rules can be applied to a title of a post to determine whether the post is a post which discusses products.

In some embodiments, pattern filter module 424 can check the titles of the posts for the names of the brands which are being considered in the product analysis. Based on this check, pattern filter module 424 can determine whether a post (e.g., a post resulting from keyword filter module 422) is a post which discusses products that are of interest for the product analysis. For example, if products from LENOVO, HP, and DELL are being analyzed, pattern filter module 424 can check the titles of the individual posts for the words “LENOVO,” “HP.” and “DELL,” including variants thereof, to make a determination as to whether a post is a post which discusses products that are of interest. For example, pattern filter module 424 can determine that a post is a post which discusses products that are of interest if at least two brand names (i.e., at least two brands which are being considered in the product analysis) are found in the title of the post. The number of brand names which need to be found in the title can be configured by the organization as part of a product analysis policy.

In other embodiments, pattern filter module 424 can filter the preprocessed title of the posts resulting from content preprocessor module 420 using lexico-syntactic pattern matching techniques, as described above, to identify posts which are comparative posts.

ML engine 426 is operable to process the posts resulting from keyword filter module 422 and/or pattern filter module 424 and further determine which of the posts are comparative posts. In some embodiments, ML engine 426 can include an ML model (e.g., long short-term memory (LSTM) artificial neural network (ANN), naïve Bayes classifier, logistic regression model, support vector machine (SVM), and the like). The ML model of ML engine 426 can be trained using machine learning techniques with a modeling dataset composed of instances of historical posts collected from various sources, where the instances of the historical posts in the modeling dataset can be labeled as either comparative or noncomparative. The training can configure the ML model to learn trends in the modeling dataset. Once the ML model is sufficiently trained, ML engine 426 can, in response to input of information about a post (e.g., a feature vector representing a post resulting from keyword filter module 422 and/or pattern filter module 424), classify the post as either a comparative post or a noncomparative post.

In some embodiments, ML engine 426 can classify the post as either a comparative post or a noncomparative post based on a predetermined probability threshold (or model confidence). For example, a post can be classified as a comparative post if the post satisfies or exceeds a predetermined probability threshold. Otherwise, if the post does not satisfy the predetermined probability threshold, the post can be classified as a noncomparative post. The probability threshold can be set by the organization as part of a product analysis policy. In some embodiments, the training of the ML model can configure the ML model to classify an input post based on the title of the post.

In some embodiments, the ML model of ML engine 426 can be retrained and/or retested with an updated modeling dataset. For example, the modeling dataset or portions of the modeling dataset can be updated to include newly or recently collected historical posts, or historical posts that have otherwise not been previously used to train and/or test the ML model.

Information extraction module 428 is operable to extract information from the posts determined to be comparative posts which discuss products that are of interest for the product analysis. In some embodiments, information extraction module 428 can utilize NLP techniques, such as named entity recognition (NER), sentiment analysis, text summarization, and aspect mining, among others, to extract information (e.g., text) from the contents of the posts. For example, for a particular post (e.g., a post resulting from ML engine 426), information extraction module 428 can utilize NLP techniques to extract comments and other content about the individual products discussed in the post. Non-limiting examples of information that can be extracted from the posts include product IDs/names, attributes and features of the compared products (e.g., speed, color, included components, price, etc.), pros and cons of the compared products, sentiment of the comment (e.g., negative, positive, and neutral), recommendation (e.g., which of the compared products is recommended), and reason for the recommendation (e.g., why a particular product is recommended).

In some embodiments, information extraction module 428 can store the comments and other content extracted from the comparative posts within data repository 418, where it can subsequently be retrieved and used. For example, in one embodiment, insight generation and reporting module 429 can retrieve the comments and other content extracted from the comparative posts discussing a product from data repository 418. Insight generation and reporting module 429 can then use the retrieved comments and other content to generate a product analysis report about the product. The generated product analysis report may then be used to derive insights about the product and other products discussed in the comparative posts.

FIG. 5 is a flow diagram of an example process 500 for analysis of competitive products, in accordance with an embodiment of the present disclosure. Illustrative process 500 may be implemented, for example, within system 400 of FIG. 4. In more detail, process 500 may be performed, for example, in whole or in part by content preprocessor module 420, keyword filter module 422, pattern filter module 424, ML engine 426, information extraction module 428, and insight generation and reporting module 429, or any combination of these including other components of system 400 described with respect to FIG. 4.

With reference to process 500 of FIG. 5, at 502, posts may be retrieved. For purposes of discussion, the posts may be retrieved in response to a product analysis request for an analysis of a product and one or more other brands. The posts, which have been previously collected from various online forums, may be retrieved from a data repository (e.g., data repository 418).

At 504, the retrieved posts may be preprocessed. For example, NLP techniques may be utilized to normalize and clean the contents of the individual posts for subsequent processing.

At 506, the content of the posts may be filtered using keywords. For example, the title and contents of the preprocessed posts may be checked for predetermined keywords indicative of comparison and for the product names and brands that are of interest for the product analysis to identify the posts which discuss products which are of interest for the product analysis. The identified posts include comparative posts which discuss products which are of interest for the product analysis.

At 508, the content of the posts may be filtered using lexico-syntactic pattern matching. For example, one or more predetermined syntactic rules (e.g., POS patterns/rules) may be applied to the titles of the posts resulting from the keyword filtering at 506 (i.e., the identified posts which discuss products which are of interest for the product analysis) to further filter the posts which are not of interest for the product analysis (e.g., filter the posts that are not comparative posts which discuss products which are of interest for the product analysis). As a result, some or all the posts which are not of interest for the product analysis and which may be included as part of the posts identified at 506 may be identified and filtered from further processing. The predetermined syntactic rules can be derived by analyzing the titles of historical comparative posts (e.g., historical social media posts discussing products and comparison of products).

At 510, the posts may be classified as either a comparative post or a noncomparative post. The classification of the posts enables further filtering of the posts that do not focus on product comparisons. For example, an ML model can be trained using a corpus of historical posts, where each historical post in the corpus in labeled as either comparative or noncomparative. Once sufficiently trained, the trained ML model can classify an input post as either a comparative post or a noncomparative post. For example, the trained ML model can classify the individual posts resulting from the lexico-syntactic pattern matching at 508 as either a comparative post or a noncomparative post.

At 512, information may be extracted from the posts classified as comparative posts at 510. For example, the posts classified as comparative posts at 510 are the posts to use for the product analysis. For example, NLP techniques can be used to extract comments and other content about the individual products discussed from the individual posts. The information extracted from these posts (e.g., comments and other content about the individual products discussed in the posts) is the information that is to be used for the product analysis. In some embodiments, the information extracted from the posts may be stored within a data repository (e.g., data repository 418).

At 514, a product analysis report about a product may be generated. The product analysis report may be about the product for which a product analysis request is received (e.g., the product specified in the product analysis request). For example, information and data to use in generating the product analysis report may be retrieved from a data repository (e.g., data repository 418). The retrieved information and data can include the comments and other content extracted from the comparative posts which discuss the product. The retrieved information and data can then be used to generate the product analysis report about the product. For example, in one embodiment, a product analysis report about a product can include the positive aspects about the product discussed in the posts, the negative aspects about the product discussed in the posts, and positive and/or negative aspects of any other brands discussed in the posts. The information in the product analysis report provides insights about the product and other similar products.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
retrieving, by a computing device, a plurality of posts collected from one or more online forums, social media platforms, or other websites;
filtering, by the computing device, the plurality of posts, wherein the filtering identifies one or more posts which discuss products which are of interest for a product analysis;
classifying, by the computing device using a machine learning (ML) model, individual posts of the filtered posts as a comparative post or a noncomparative post, wherein the posts classified as comparative posts are used for the product analysis;
extracting, by the computing device, information from the comparative posts, wherein the information is to be used for the product analysis; and
storing, by the computing device, the extracted information within a data repository.

2. The method of claim 1, wherein the filtering includes filtering content of the plurality of posts using keywords indicative of comparison and names of products which are of interest for the product analysis.

3. The method of claim 2, wherein at least one keyword of the keywords is derived from historical posts.

4. The method of claim 2, wherein the one or more posts which discuss products which are of interest for a product analysis are identified based on a threshold match percentage of the keywords indicative of comparison and the names of products which are of interest for the product analysis.

5. The method of claim 1, wherein the filtering includes filtering content of the plurality of posts using lexico-syntactic pattern matching.

6. The method of claim 5, wherein the lexico-syntactic pattern matching is of titles of the plurality of posts.

7. The method of claim 5, wherein the lexico-syntactic pattern matching includes applying one or syntactic rules to titles of the plurality of posts.

8. The method of claim 7, wherein at least one of the one or more syntactic rules is derived from historical comparative posts.

9. The method of claim 1, wherein the filtering includes filtering content of the plurality of posts using keywords indicative of comparison and names of products which are of interest for the product analysis and lexico-syntactic pattern matching.

10. The method of claim 1, wherein the ML model is trained using instances of historical posts labeled as either comparative or noncomparative.

11. The method of claim 1, further comprising:
retrieving, by the computing device from the data repository, the information extracted from the comparative posts; and
generating, by the computing device, a product analysis report using the information retrieved from the data repository.

12. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
retrieving a plurality of posts collected from one or more online forums, social media platforms, or other websites;
filtering the plurality of posts, wherein the filtering identifies one or more posts which discuss products which are of interest for a product analysis;
classifying, using a machine learning (ML) model, individual posts of the filtered posts as a comparative post or a noncomparative post, wherein the posts classified as comparative posts are used for the product analysis;
extracting information from the comparative posts, wherein the information is to be used for the product analysis; and
storing the extracted information within a data repository.

13. The computing device of claim 12, wherein the filtering includes filtering content of the plurality of posts using keywords indicative of comparison and names of products which are of interest for the product analysis.

14. The computing device of claim 13, wherein the one or more posts which discuss products which are of interest for a product analysis are identified based on a threshold match percentage of the keywords indicative of comparison and the names of products which are of interest for the product analysis.

15. The computing device of claim 12, wherein the filtering includes filtering content of the plurality of posts using lexico-syntactic pattern matching.

16. The computing device of claim 15, wherein the lexico-syntactic pattern matching includes applying one or more syntactic rules to titles of the plurality of posts.

17. The computing device of claim 12, wherein the filtering includes filtering content of the plurality of posts using keywords indicative of comparison and names of products which are of interest for the product analysis and lexico-syntactic pattern matching.

18. A non-transitory machine-readable medium encoding instructions that when executed by one or more processors cause a process to be carried out, the process including:
retrieving a plurality of posts collected from one or more online forums, social media platforms, or other websites;
filtering the plurality of posts, wherein the filtering identifies one or more posts which discuss products which are of interest for a product analysis;
classifying, using a machine learning (ML) model, individual posts of the filtered posts as a comparative post or a noncomparative post, wherein the posts classified as comparative posts are used for the product analysis;
extracting information from the comparative posts, wherein the information is to be used for the product analysis; and
storing the extracted information within a data repository.

19. The machine-readable medium of claim 18, wherein the filtering includes filtering content of the plurality of posts using keywords indicative of comparison and names of products which are of interest for the product analysis.

20. The machine-readable medium of claim 18, wherein the filtering includes filtering content of the plurality of posts using lexico-syntactic pattern matching.
